(19) United States
(12) Patent Application Publication
(10) Pub. No.: US 2014/0303949 A1
(43) Pub. Date: Oct. 9, 2014

(54) SIMULATION OF PRODUCTION SYSTEMS

(71) Applicant: Schlumberger Technology Corporation, Sugar Land, TX (US)

(72) Inventors: Carlos Santieri de Figueiredo Boneti, Houston, TX (US); Rodney Lessard, Katy, TX (US); Bobby Kiehn, Houston, TX (US); Fabien Houeto, Sugar Land, TX (US)

(73) Assignee: Schlumberger Technology Corporation, Sugar Land, TX (US)

(21) Appl. No.: 14/246,591

(22) Filed: Apr. 7, 2014

Related U.S. Application Data
(60) Provisional application No. 61/810,062, filed on Apr. 9, 2013.

(51) Int. Cl. G06F 17/50; G06F 3/0484

(52) U.S. Cl. CPC G06F 17/5009; G06F 17/509; G06F 3/0484
USPC 703/6; 715/771

(57) ABSTRACT

A method can include, via an interface of a computing system, receiving information representing a change to a network model of a production system; via the computing system, simulating at least a portion of the production system based at least in part on a portion of the information and at least a portion of the network model to generate simulation results; and, via the interface, transmitting at least a portion of the simulation results. Various other technologies, techniques, etc., are also disclosed.

### RELATED APPLICATIONS

This applications claims priority to and the benefit of a U.S. Provisional patent application having Ser. No. 61/810,062, filed 9 Apr. 2013, which is incorporated herein by reference.

### BACKGROUND

Production systems can provide for transportation of oil and gas fluids from well locations to processing facilities and represent a substantial investment in infrastructure with both economic and environmental impact. Simulation of such systems, which may include hundreds or thousands of flowlines and production equipment interconnected at junctions to form a network, can be a formidable task,

### SUMMARY

A method can include, via an interface of a computing system, receiving information representing a change to a network model of a production system; via the computing system, simulating at least a portion of the production system based at least in part on a portion of the information and at least a portion of the network model to generate simulation results; and, via the interface, transmitting at least a portion of the simulation results. A system can include an interface; processor cores; memory accessible by the processor cores; one or more modules stored in the memory where the one or more modules include processor-executable instructions to instruct the system to receive via the interface information germane to a network model of a production system; simulate via at least one of the processor cores at least a portion of the production system based at least in part on a portion of the information and at least a portion of the network model to generate simulation results; and transmit via the interface at least a portion of the simulation results. One or more computer-readable storage media can include computer-executable instructions executable by a computer to instruct the computer to: render a graphical user interface to a display where the graphical user interface includes a panel that displays at least a portion of a network model of a production system; receive input via an input mechanism of the computer where the input is germane to the network model; and formulate a call for transmission to an interface of a simulation service where the call is based at least in part on the input.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example field system that includes various components, an example of a method and an example of a device or system;

FIG. 2 illustrates an example of a system;

FIG. 3 illustrates an example of a system;

FIG. 4 illustrates an example of a network, which may be a sub-network of a more comprehensive network;

FIG. 5 illustrates an example of a system;

FIG. 6 illustrates an example of a method;

FIG. 7 illustrates an example of a system, an example of a services layer and examples of resources;

FIG. 8 illustrates an example of a graphical user interface and an example of a scenario;

FIG. 9 illustrates examples of methods and examples of graphical user interfaces;

FIG. 10 illustrates an example of a graphical user interface;

FIG. 11 illustrates an example of a method; and

FIG. 12 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

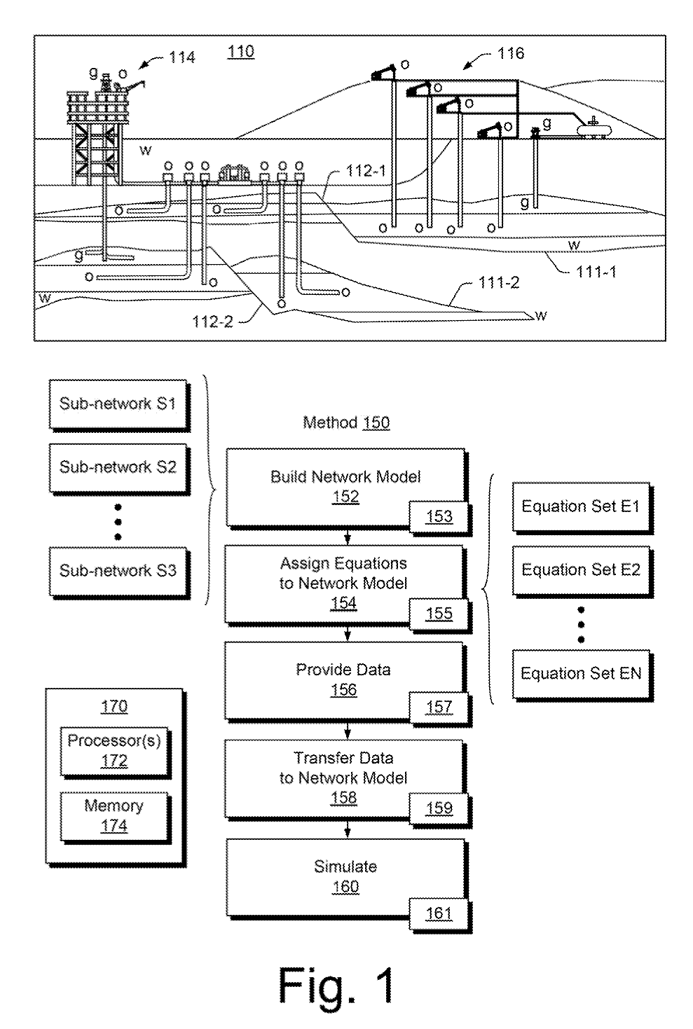

FIG. 1 shows an example of a geologic environment 110 that includes reservoirs 111-1 and 111-2, which may be faulted by faults 112-1 and 112-2, an example of a method 150 and an example of a device or system 170. FIG. 1 also shows some examples of offshore equipment 114 for oil and gas operations related to the reservoirs 111-1 and 111-2 and onshore equipment 116 for oil and gas operations related to the reservoir 111-1.

As an example, a model may be made that models a geologic environment in combination with equipment, wells, etc. For example, a model may be a flow simulation model for use by a simulator to simulate flow in an oil, gas or oil and gas production system. Such a flow simulation model may include equations, for example, to model multiphase flow from a reservoir to a wellhead, from a wellhead to a reservoir, etc. A flow simulation model may also include equations that account for flowline and surface facility performance, for example, to perform a comprehensive production system analysis.

As an example, a flow simulation model may be a network model that includes various sub-networks specified using nodes, segments, branches, etc. As an example, a flow simulation model may be specified in a manner that provides for modeling of branched segments, multilateral segments, complex completions, intelligent downhole controls, etc.

As an example, a system may provide for transportation of oil and gas fluids from well locations to processing facilities and may represent a substantial investment in infrastructure with both economic and environmental impact. Simulation of such a system, which may include hundreds or thousands of flow lines and production equipment interconnected at junctions to form a network, can involve multiphase flow science and, for example, use of engineering and mathematical techniques for large systems of equations.

As an example, a flow simulation model may include equations for performing nodal analysis, pressure-volume-temperature (PVT) analysis, gas lift analysis, erosion analysis, corrosion analysis, production analysis, injection analysis, etc. In such an example, one or more analyses may be based, in part, on a simulation of flow in a modeled network.

As to nodal analysis, it may provide for evaluation of well performance, for making decisions as to completions, etc. A nodal analysis may provide for an understanding of behavior of a system and optionally sensitivity of a system (e.g., production, injection, production and injection). For example, a system variable may be selected for investigation and a sensitivity analysis performed. Such an analysis may include plotting inflow and outflow of fluid at a nodal point or nodal points in the system, which may indicate where certain opportunities exist (e.g., for injection, for production, etc.).

A modeling framework may include modules to facilitate generation of a flow simulation model. For example, a module may provide for modeling completions for vertical wells, completions for horizontal wells, completions for fractured wells, etc. A modeling framework may include modules for particular types of equations, for example, black-oil equations, equation-of-state (EOS) equations, etc. A modeling framework may include modules for artificial lift, for example, to model fluid injection, fluid pumping, etc. As an example, consider a module that includes features for modeling one or more electric submersible pumps (ESPs) (e.g., based in part on pump performance curves, motors, cables, etc.).

As an example, an analysis using a flow simulation model may be a network analysis to identify production bottlenecks and constraints; assess benefits of new wells, additional pipelines, compression systems, etc.; calculate deliverability from field gathering systems; predict pressure and temperature profiles through flow paths; or plan full-field development.

As an example, a flow simulation model may provide for analyses with respect to future times, for example, to allow for optimization of production equipment, injection equipment, etc. As an example, consider an optimal time-based and conditional-event logic representation for daily field development operations that can be used to evaluate drilling of new developmental wells, installing additional processing facilities over time, choke-adjusted wells to meet production and operating limits, shutting in of depleting wells as reservoir conditions decline, etc.

As to equations, a flow simulation model may include one or more sets of equations for three-phase mechanistic multiphase flow (e.g., according to one or more of a LedaFlow™ point model (Kongsberg Oil & Gas Technologies AS, Sandvika, Norway), ALGA-S™ model (Schlumberger Ltd, Houston, Tex.), TUFFP unified mechanistic models (Tulsa University Fluid Flow Projects, Tulsa, Okla.), etc.).

As to the method 150 of FIG. 1, it can include a build block 152 for building a network model that represents a production system for fluid; an assignment block 154 for assigning equations to sub-networks in the network model (e.g., where at least one of the sub-networks is optionally assigned equations formulated for solving for enthalpy implicitly or temperature implicitly), a provision block 156 for providing data; a transfer block 158 for transferring the data to the network model; and a simulation block 160 for simulating physical phenomena associated with the production system using the network model to provide simulation results.

The method 150 is shown in FIG. 1 in association with various computer-readable media (CRM) blocks 153, 155, 157, 159 and 161. Such blocks generally include instructions suitable for execution by one or more processors (or processing cores) 172 to instruct the computing device or system 170 to perform one or more actions. While various blocks are shown, a single medium may be configured with instructions to allow for, at least in part, performance of various actions of the method 150. As an example, a computer-readable medium (CRM) may be a computer-readable storage medium, for example, such as a memory device 174 of the computing device or system 170, where the memory device 174 includes memory.

A production system can include equipment, for example, where a piece of equipment of the production system may be represented in a sub-network of a network model and, for example, assigned equations formulated to represent the piece of equipment as non-adiabatic (e.g., or adiabatic). As an example, a piece of equipment may include an electric motor operatively coupled to a mechanism to move fluid (e.g., a pump, compressor, etc.). As an example, a piece of equipment may include a heater coupled to a power source, a fuel source, etc. (e.g., consider a steam generator). As an example, a piece of equipment may include a conduit for delivery of fluid where the fluid may be for delivery of heat energy (e.g., consider a steam injector). As an example, a piece of equipment may include a conduit for delivery of a substance (e.g., a chemical, a proppant, etc.).

As an example, a sub-network may be assigned equations formulated for solving for enthalpy implicitly or temperature implicitly to represent fluid at or near a critical point, to represent heavy oil, to represent steam, to represent water or one or more other fluids (e.g., optionally subject to certain physical phenomena such as pressure, temperature, etc.).

As an example, a system can include a processor; a memory device having memory accessible by the processor; and one or more modules that include processor-executable instructions stored in the memory of the memory device, the instructions executable to instruct the system to: build a network model that represents a production system for fluid, assign equations to sub-networks in the network model, provide data, transfer the data to the network model, and simulate physical phenomena associated with the production system using the network model to provide simulation results.

As an example, a system can include a sub-network assigned equations formulated for steam associated with equipment for an enhanced oil recovery (EOR) process (e.g., steam-assisted gravity drainage (SAGS) and/or other EOR process).

As an example, a system can include a sub-network that represents a piece of equipment of a production system by assigning that sub-network equations formulated to represent the piece of equipment. In such an example, the piece of equipment may include an electric motor operatively coupled to a mechanism to move fluid (e.g., a compressor, a pump, etc.).

As an example, one or more computer-readable media can include computer-executable instructions executable by a computer to instruct the computer to: receive simulation results for physical phenomena associated with a production system modeled by a network model; and analyze the simulation results.

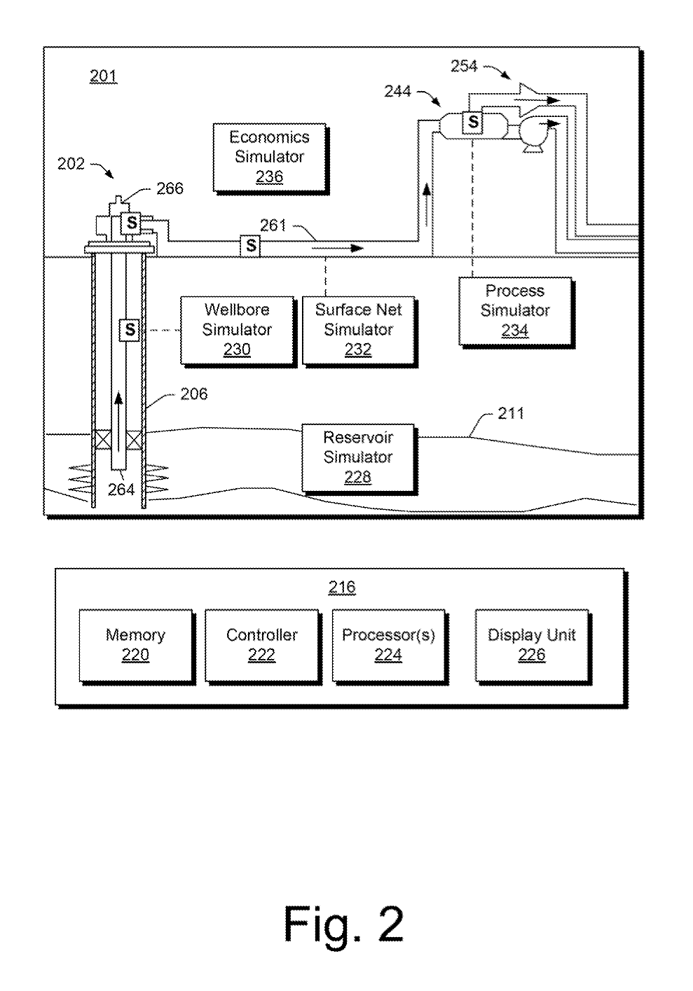

FIG. 2 shows an example of a schematic view of a portion of a geologic environment 201 that includes equipment. As shown in FIG. 2, the environment 201 includes a wellsite 202 and a network 244. The wellsite 202 includes a wellbore 206 extending into earth as completed and prepared for production of fluid from a reservoir 211.

In the example of FIG. 2, wellbore production equipment 264 extends from a wellhead 266 of the wellsite 202 and to the reservoir 211 to draw fluid to the surface. As shown, the wellsite 202 is operatively connected to the network 244 via a transport line 261. As indicated by various arrows, fluid can flow from the reservoir 211, through the wellbore 206 and onto the network 244. Fluid can then flow from the network 244, for example, to one or more fluid processing facilities.

In the example of FIG. 2, sensors (S) are located, for example, to monitor various parameters during operations. The sensors (S) may measure, for example, pressure, temperature, flowrate, composition, and other parameters of the reservoir, wellbore, gathering network, process facilities and/or other portions of an operation. As an example, the sensors (S) may be operatively connected to a surface unit 216 (e.g., to instruct the sensors to acquire data, to collect data from the sensors, etc.).

In the example of FIG. 2, the surface unit 216 can include computer facilities, such as a memory device 220, a controller 222, one or more processors 224, and display unit 226 (e.g., for managing data, visualizing results of an analysis, etc.). As an example, data may be collected in the memory device 220 and processed by the processor(s) 224 (e.g., for analysis, etc.). As an example, data may be collected from the sensors (S) and/or by one or more other sources. For example, data may be supplemented by historical data collected from other operations, user inputs, etc. As an example, analyzed data may be used to in a decision making process.

In the example of FIG. 2, a transceiver may be provided to allow communications between the surface unit 216 and one or more pieces of equipment in the environment 201. For example, the controller 222 may be used to actuate mechanisms in the environment 201 via the transceiver, optionally based on one or more decisions of a decision making process. In such a manner, equipment in the environment 201 may be selectively adjusted based at least in part on collected data. Such adjustments may be made, for example, automatically based on computer protocol, manually by an operator or both. As an example, one or more well plans may be adjusted (e.g., to select optimum operating conditions, to avoid problems, etc.).

To facilitate data analyses, one or more simulators may be implemented (e.g., optionally via the surface unit 216 or other unit, system, etc.). As an example, data fed into one or more simulators may be historical data, real time data or combinations thereof. As an example, simulation through one or more simulators may be repeated or adjusted based on the data received.

In the example of FIG. 2, simulators can include a reservoir simulator 228, a wellbore simulator 230, and a surface network simulator 232, a process simulator 234 and an economics simulator 236. As an example, the reservoir simulator 228 may be configured to solve for hydrocarbon flow rate through a reservoir and into one or more wellbores. As an example, the wellbore simulator 230 and surface network simulator 232 may be configured to solve for hydrocarbon flow rate through a wellbore and a surface gathering network of pipelines. As to the process simulator 234, it may be configured to model a processing plant where fluid containing hydrocarbons is separated into its constituent components (e.g., methane, ethane, propane, etc.), for example, and prepared for further distribution (e.g., transport via road, rail, pipe, etc.) and optionally sale. As an example, the economics simulator 236 may be configured to model costs associated with at least part of an operation.

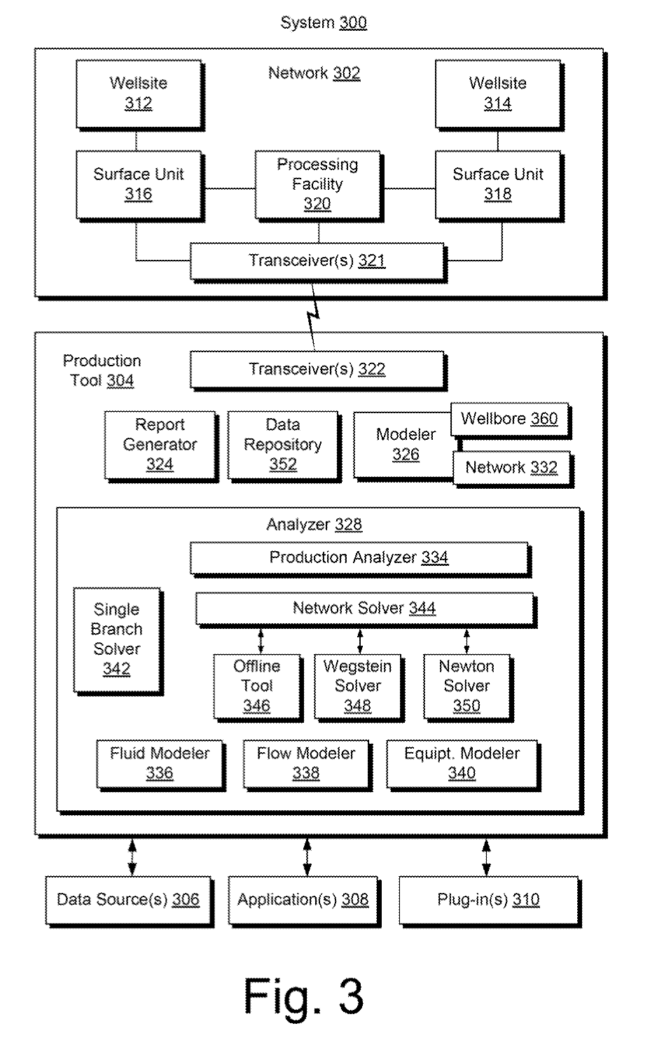

FIG. 3 shows an example of a schematic diagram of a production system 300 for performing oilfield production operations. As shown in the example of FIG. 3, the production system 300 can include an oilfield network 302, an oilfield production tool 304, one or more data sources 306, one or more oilfield application(s) 308, and one or more plug-in(s) 310. As an example, the oilfield network 302 can be an interconnection of pipes (e.g., conduits) that connects wellsites (e.g., a wellsite 1 312, a wellsite n 314, etc.) to a processing facility 320. A pipe in the oilfield network 302 may be connected to a processing facility (e.g., a processing facility 320), a wellsite (e.g., the wellsite 1 312, the wellsite n 314, etc.), and/or a junction in which pipes are connected. As an example, flow rate of fluid and/or gas into pipes may be adjustable; thus, certain pipes in the oilfield network 302 may be choked or closed so as to not allow fluid and/or gas through the pipe. A pipe may be considered open (e.g., optionally choked) when the pipe allows for flow of fluid and/or gas. As to a choke, choking may allow for adjusting one or more characteristics of a piece of flow equipment (e.g., a cross-sectional flow area, etc.), for example, for adjusting to fully open flow, for adjusting to choked flow and/or for adjusting to no flow (e.g., closed).

As an example, a choke may include an orifice that is used to control fluid flow rate or downstream system pressure. As an example, a choke may be provided in any of a variety of configurations (e.g., for fixed and/or adjustable modes of operation). As an example, an adjustable choke may enable fluid flow and pressure parameters to be changed to suit process or production requirements. As an example, a fixed choke may be configured for resistance to erosion under prolonged operation or production of abrasive fluids.

The oilfield network 302 may be a gathering network and/or an injection network. A gathering network may be an oilfield network used to obtain hydrocarbons from a wellsite (e.g., the wellsite 1 312, the wellsite n 314, etc.). In a gathering network, hydrocarbons may flow from the wellsites to the processing facility 320. An injection network may be an oilfield network used to inject the wellsites with injection substances, such as water, carbon dioxide, and other chemicals that may be injected into the wellsites. In an injection network, the flow of the injection substance may flow towards the wellsite (e.g., toward the wellsite 1 312, the wellsite n 314, etc.).

The oilfield network 302 may also include one or more surface units (e.g., a surface unit 1 316, a surface unit n 318, etc.), for example, a surface unit for each wellsite. Such surface units may include functionality to collect data from sensors (see, e.g., the surface unit 216 of FIG. 2). Such sensors may include sensors for measuring flow rate, water cut, gas lift rate, pressure, and/or other such variables related to measuring and monitoring hydrocarbon production.

As an example, the oilfield production tool 304 may be connected to the oilfield network 302. The oilfield production tool 304 may be a simulator (e.g., a simulation framework) or a plug-in for a simulator (e.g., or other application(s)). The oilfield production tool 304 may include one or more transceivers 322, a report generator 324, an oilfield modeler 326, and an oilfield analyzer 328. As an example, the one or more transceivers 322 may be configured to receive information, to transmit information, to receive information and transmit information, etc. As an example, information may be received and/or transmitted via wire and/or wirelessly. As an example, information may be received and/or transmitted via a communications network such as, for example, the Internet, the Cloud, a cellular network, a satellite network, etc.

As an example, one or more of the one or more transceivers 322 may include functionality to collect oilfield data. The oilfield data may be data from sensors, historical data, or any other such data. One or more of the one or more transceivers 322 may also include functionality to interact with a user and display data such as a production result.

As an example, the report generator 324 can include functionality to produce graphical and textual reports. Such reports may show historical oilfield data, production models, production results, sensor data, aggregated oilfield data, or any other such type of data.

As an example, the data repository 352 may be a storage unit and/or device (e.g., a file system, database, collection of tables, or any other storage mechanism) for storing data, such as the production results, sensor data, aggregated oilfield data, or any other such type of data. As an example, the data repository 352 may include multiple different storage units and/or hardware devices. Such multiple different storage units and/or devices may or may not be of the same type or located at the same physical site. As an example, the data repository 352, or a portion thereof, may be secured via one or more security protocols, whether physical, algorithmic or a combination thereof (e.g. data encryption, secure device access, secure communication, etc.).

In the example of FIG. 3, the oilfield modeler 326 can include functionality to create a model of a wellbore and an oilfield network. As shown, the oilfield modeler 326 includes a wellbore modeler 330 and a network modeler 332. As an example, the wellbore modeler 330 can allow a user to create a graphical wellbore model or single branch model. As an example, a wellbore model can define operating parameters (e.g., actual, theoretical, etc.) of a wellbore (e.g., pressure, flow rate, etc). As an example, a single branch model may define operating parameters of a single branch in an oilfield network.

As to the network modeler 332, it may allow a user to create a graphical network model that combines wellbore models and/or single branch models. As an example, the network modeler 328 and/or wellbore modeler 330 may model pipes in the oilfield network 302 as branches of the oilfield network 302 (e.g., optionally as one or more segments, optionally with one or more nodes, etc.). In such an example, each branch may be connected to a wellsite or a junction. A junction may be defined as a group of two or more pipes that intersect at a particular location (e.g. a junction may be a node or a type of node).

As an example, a modeled oilfield network may be formed as a combination of sub-networks. In such an example, a sub-network may be defined as a portion of an oilfield network. For example, a sub-network may be connected to the oilfield network 302 using at least one branch. Sub-networks may be a group of connected wellsites, branches, and junctions. As an example, sub-networks may be disjoint (e.g., branches and wellsites in one sub-network may not exist in another sub-network).

As an example, the oilfield analyzer 328 can include functionality to analyze the oilfield network 302 and generate a production result for the oilfield network 302. As shown in the example of FIG. 3, the oilfield analyzer 328 may include one or more of the following: a production analyzer 334, a fluid modeler 336, a flow modeler 338, an equipment modeler 340, a single branch solver 342, a network solver 344, a Wegstein solver 346, a Newton solver 350, and an offline tool 346.

As an example, the production analyzer 334 can include functionality to receive a workflow request and interact with the single branch solver 342 and/or the network solver 344 based on particular aspects of the workflow. For example, the workflow may include a nodal analysis to analyze a wellsite or junction of branches, pressure and temperature profile, model calibration, gas lift design, gas lift optimization, network analysis, and other such workflows.

As an example, the fluid modeler 336 can include functionality to calculate fluid properties (e.g., phases present, densities, viscosities, etc.) using one or more compositional and/or black-oil fluid models. The fluid modeler 336 may include functionality to model oil, gas, water, hydrate, wax, and asphaltene phases. As an example, the flow modeler 338 can include functionality to calculate pressure drop in pipes (e.g., pipes, tubing, etc.) using industry standard multiphase flow correlations. As an example, the equipment modeler 340 can include functionality to calculate pressure changes in equipment pieces (e.g., chokes, pumps, compressors, etc.). As an example, one or more substances may be introduced via a network for purposes of managing asphaltenes, waxes, etc. As an example, a modeler may include functionality to model interaction between one or more substances and fluid (e.g., including material present in the fluid).

As an example, the single branch solver 342 may include functionality to calculate the flow and pressure drop in a wellbore or a single flowline branch given various inputs.

As an example, the network solver 344 can includes functionality calculate a flow rate and pressure drop throughout the oilfield network 302. The network solver 344 may be configured to connect to the offline tool 346, the Wegstein solver 348, and the Newton solver 350. As an example, alternatively or additionally, one or more other solvers may be provided, for example, consider a sequential linear programming solver (SLP), a sequential quadratic programming solver (SQP), etc. As an example, a solver may be part of the production tool 304, part of the analyzer 328 of the production tool 304, part of a system to which the production tool 304 may be operatively coupled, etc.

As an example, the offline tool 346 may include a wells offline tool and a branches offline tool. A wells offline tool may include functionality to generate a production model using the single branch solver 342 for a wellsite or branch. A branches offline tool may include functionality to generate a production model for a sub-network using the production model for a wellsite, a single branch, or a sub-network of the sub-network.

As an example, a production model may be capable of providing a description of a wellsite with respect to various operational conditions. A production model may include one or more production functions that may be combined, for example, where each production function may be a function of variables related to the production of hydrocarbons. For example, a production function may be a function of flow rate and/or pressure. Further, a production function may account for environmental conditions related to a sub-network of the oilfield network 302, such as changes in elevation (e.g., for gravity head, pressure, etc.), diameters of pipes, combination of pipes, and changes in pressure resulting from joining pipes. A production model may provide estimates of flow rate for a wellsite or sub-network of an oilfield network.

As an example, one or more separate production functions may exist that can account for changes in one or more values of an operational condition. An operational condition may identify a property of hydrocarbons or injection substance. For example, an operational condition may include a watercut (WC), reservoir pressure, gas lift rate, etc. Other operational conditions, variables, environmental conditions may be considered.

As to the network solver 344, in the example of FIG. 3, it is shown as being connected to the Wegstein solver 348 and/or the Newton solver 350. The Wegstein solver 348 and the Newton solver 350 include functionality to combine a production model for several sub-networks to create a production result that may be used to plan an oilfield network, optimize flow rates of wellsites in an oilfield network, and/or identify and address faulty components within an oilfield network. The Wegstein solver 348 can use an iterative method with Wegstein acceleration.

An oilfield network may be solved by identifying pressure drop (e.g., pressure differential), for example, through use of momentum equations. As an example, an equation for pressure differential may account for factors such as fluid potential energy (e.g., hydrostatic pressure), friction (e.g., shear stress between conduit wall and fluid), and acceleration (e.g., change in fluid velocity). As an example, an equation may be expressed in terms of static reservoir pressure, a flowing bottom hole pressure and flowrate. As an example, equations may account for vertical, horizontal or angled arrangements of equipment. Various examples of equations may be found in a multiphase flow simulator such as the simulator of the PIPESIM™ simulation framework (Schlumberger Limited, Houston, Tex.), which may be implemented for design and diagnostic analysis of oil and gas production systems. As an example, a simulation framework may include modules that, for example, provide for building a model; fluid and multiphase flow modeling; reservoir, well and completion modeling; field equipment modeling; and operations (e.g., artificial lift, gas lift, wax prediction, nodal analysis, network analysis, field planning, multi-well analysis, etc.).

As an example, an equation for pressure differential (e.g., ΔP) may be rearranged to solve for flow rate (e.g., Q), where the equation may include the Reynolds number (e.g., Re, a dimensionless ratio of inertial to viscous forces), one or more friction factors (e.g., which may depend on flow regime), etc.

Through use of equations for flow into and out of a branch and equating to zero, a linear matrix in unknown pressures may be obtained. As an example, fixed flow branches (i.e., branches in which the flow does not change) may be solved directly for the node pressures.

Thus, as an example, the Wegstein Solver 348 may perform a process as follows: (1) obtain initial estimates for the frictional and elevational resistances from the production models; (2) solve the linear system for the unknown node pressures; (3) calculate resulting flow rates; (4) calculate pressure residuals at each internal node; and (5) determine whether the maximum of the pressure residuals is lower than the desired tolerance. If the maximum pressure residual is not lower than the desired tolerance then the Wegstein solver may continue by rerun all the branches, with the pressure and flows calculated in items (2) and (3) above to re-estimate the branch resistances. Further, Wegstein acceleration may be applied to the resistances before returning to item (2).

The Newton solver 344 implements a Newton-Raphson technique for solving a system of non-linear equations. The Newton-Raphson technique can be applied iteratively for solving a system of non-linear equations defined by a vector of unknown variables and associated residual equations. Following an initial guess, iterations commence, for example, until one or more criteria are met (e.g., number of iterations, error, etc.). Updates for each iteration of the Newton-Raphson technique may be generated by solving a matrix equation that includes a Jacobian matrix formed by differentiating residual equations with respect to the variables. As an example, an adjustable factor may be used to adjust from a pure Newton-Raphson type of update to another type of update.

The Newton solver 344 includes functionality to solve the oilfield network 302 by implementing the Newton method (discussed above). Below is an example of how the Newton solver may be used to solve oilfield network 302.

For solving an oilfield network, a process may include: (1) defining variables and residual equations; (2) determine initial solution; (3) calculating residual and Jacobian matrix for each iteration; (4) solve Jacobian equation for the Newton update; (5) optionally determining adjustment factor; and (6) updating the solution.

With regards to item (1), defining variables and residual equations, branches in an oilfield network may include a number of equipment items. Each branch may be divided into sub-branches with each sub-branch containing a single equipment item. As an example, a new node may be used to join each pair of sub-branches. In this example, primary Newton-Raphson variables can include a flow (Q_{ib}) in each sub-branch in the network and a pressure Pᵢₙ at each node in the network. In this example, temperature (or enthalpy) and composition may be treated as secondary variables.

As an example, residual equations may include a branch residual, an internal node residual, and a boundary condition. In such an example, a branch residual for a sub-branch relates the branch flow to the pressure at the branch inlet node and the pressure at the outlet node. As an example, internal node residuals can define where total flow into a node is equal to total flow out of the node.

As an example, determining an initial solution may be performed using a production model where for each subsequent iteration, a Jacobian matrix is calculated. The values of the Jacobian matrix may be used to solve a Jacobian equation for the Newton-Raphson update. To solve the Jacobian equation, one or more types of matrix solvers may be used.

In the example of FIG. 3, the one or more data sources 306 include one or more types of repositories for data. For example, the one or more data sources 306 may be Internet sources, sources from a company having ties to the oilfield network 302, or any other location in which data may be obtained. The data may include historical data, data collected from other oilfield networks, data collected from the oilfield network being modeled, data describing environmental or operational conditions.

In the example of FIG. 3, the one or more oilfield applications 308 may be applications related to the production of hydrocarbons. The one or more oilfield applications 308 may include functionality to evaluate a formation, manage drilling operations, evaluate seismic data, evaluate workflows in the oilfield, perform simulations, or perform any other oilfield related function. In the example of FIG. 3, the one or more plug-ins 310 may allow integration with packages such as, for example, a TUFPP model, an OLGA™ model, an Infochem Multiflash model (Infochem Computer Services Ltd., London, UK), an equipment model, etc.

While the example of FIG. 3 shows the oilfield production tool 304 as a separate component from the oilfield network 302, the oilfield production tool 304 may alternatively be part of the oilfield network 302. For example, the oilfield production tool 304 may be located at one of the wellsites (e.g., the wellsite 1 312, the wellsite n 314, etc.), at the processing facility 320, or any other location in the oilfield network 302. As another example, the oilfield production tool 304 may exist separate from the oilfield network 302, such as when the oilfield production tool 304 is used to plan the oilfield network.

Various types of numerical solution schemes may be characterized as being explicit or implicit. For example, when a direct computation of dependent variables can be made in terms of known quantities, a scheme may be characterized as explicit. Whereas, when dependent variables are defined by coupled sets of equations, and either a matrix or iterative technique is implemented to obtain a solution, a scheme may be characterized as implicit.

As an example, a scheme may be characterized as adaptive implicit (“AIM”). An AIM scheme may adapt, for example, based on one or more gradients as to one or more variables, properties, etc, of a model. For example, where a model of a subterranean environment includes a region where porosity varies rapidly with respect to one or more physical dimensions (e.g., x, y, or z), a solution for one or more variables in that region may be modeled using an implicit scheme while an overall solution for the model also includes an explicit scheme (e.g. for one or more other regions for the same one or more variables).

As an example of an AIM scheme, consider an AIM scheme available as part of the ECLIPSE™ 300 reservoir simulator marketed by Schlumberger Ltd. (Houston, Tex.). The ECLIPSE™ 300 reservoir simulator may implement a fully implicit scheme or an implicit-explicit scheme that is implicit in pressure and explicit in saturation, known as IMPES. In the fully implicit scheme, values for both pressure and saturation are provided at the end of each simulation time-step; whereas, the IMPES scheme uses saturation values from the beginning of the time-step to solve for pressure values at the end of the time-step. In such examples, a reservoir simulator iterates until pressures values in grid blocks of a model of the reservoir being simulated have reached some internally consistent solution. However, a solution may be difficult to find if saturation (which the IMPES scheme assumes is constant within a time-step) changes rapidly during that time-step (e.g., a large percentage change in grid block values for saturation). The IMPES scheme may be able to cope with such an issue by decreasing “length” (e.g., duration) of the time-step but at the cost of more time-steps (e.g., in an effort to achieve a more stable solution).

The aforementioned fully implicit scheme may be a more stable option with saturation and pressure being obtained simultaneously so as any difference between their values for one time-step and a next time-step does not disturb a solution process as much as when compared to the IMPES scheme. Thus, in a fully implicit scheme, the “length” (e.g., duration) of a time-step may be larger but it also means that the fully implicit scheme may take additional processing time to achieve solutions (e.g., in comparison with an IMPES scheme). However, in a reservoir where properties change rapidly, a fully implicit scheme may provide a solution in less computational time than an IMPES scheme, even though an iteration of the fully implicit scheme may take longer to complete when compared to an iteration of the IMPES scheme.

The aforementioned ECLIPSE™ 300 reservoir simulator may also implement one or more modules such as a black-oil simulator module, a compositional simulator module, or a thermal simulator module. As an example, a black-oil simulator module may include equations to model three fluid phases (e.g., oil, water, and gas, with gas dissolving in oil and oil vaporizing in gas); as an example, a compositional simulator module may include equations to model phase behavior and compositional changes; and, as an example, a thermal simulator module may include equations to model a thermal recovery processes such as steam-assisted gravity drainage (SAGS), cyclic stream operations, in-situ combustion, heater, and cold heavy oil production with sand.

As to network models, as an example, a method can include simulation of steady state operation of an oil and gas production system over various ranges of operating conditions and configurations. In such an example, the method may include an implicit evaluation of conservation of energy equations in addition to mass and momentum as an effective technique for efficiently and robustly simulating the production system where, for example, the production system includes fluid such as heavy oil, steam or other fluids at or near critical pressures or temperatures. The term “critical point” is sometimes used herein to specifically denote a vapor-liquid critical point of a material, above which distinct liquid and gas phases do not exist.

As mentioned, a production system can provide for transportation of oil and gas fluids from well locations along flowlines which are interconnected at junctions to combine fluids from many wells for delivery to a processing facility. Along these flowlines (including at one or more ends of a flowline), production equipment may be inserted to modify the flowing characteristics like flow rate, pressure, composition and temperature. As an example, a boundary condition may depend on a type of equipment, operation of a piece of equipment, etc.

As an example, a simulation may be performed using one type of equipment along a flowline and another simulation may be performed using another type of equipment along the same flowline, for example, to determine which type of equipment may be selected for installation in a production system.

As an example, a simulation may be performed using one type of equipment at a position (e.g., with respect to a flowline) and another simulation may be performed using another type of equipment at a different position (e.g., with respect to the same flowline or a different flowline), for example, to determine which type of equipment may be selected for installation in a production system as well as to determine where a type of equipment may be installed. As an example, a simulation may be performed using one type of equipment at a position (e.g., with respect to a flowline) and another simulation may be performed using that type of equipment at a different position (e.g., with respect to the same flowline or a different flowline), for example, to determine where that type of equipment may be installed.

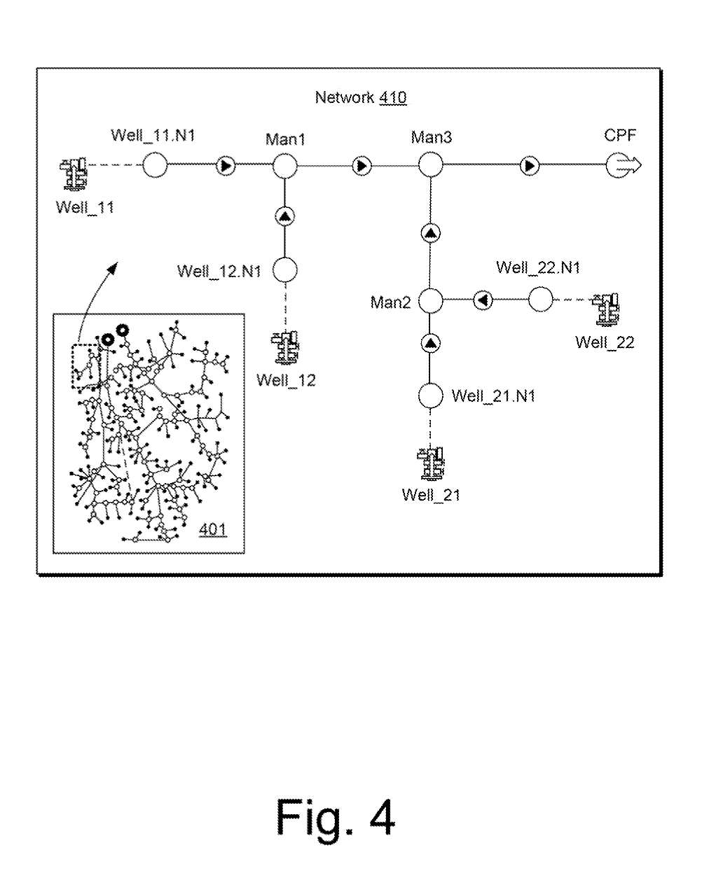

FIG. 4 shows an example of a relatively small production system network 410 (e.g., which may be a portion of a larger network 401). As shown, the network 410 forms somewhat of a tree like structure where flowlines represent branches (e.g., segments) and junctions represent nodes. As shown in FIG. 4, the network 410 provides for transportation of oil and gas fluids from well locations along flowlines interconnected at junctions with final delivery at a central processing facility.

Given information of operating condition(s) at boundary nodes (e.g., where fluid enters and exists the system) and the physical environment between them (e.g., geographical location, elevation and ambient temperature), a production engineer may aim to design a production system that meets business and regulatory requirements constrained to operating limits of available equipment.

As an example, a method can include implementing one or more modules to simulate steady state operation of a production system, for example, as including a network (e.g., as a sub-network, etc.) as in the example of FIG. 4 (also see, e.g., FIG. 1). Such a method may include simulating the steady state operation over a selected range of operating conditions and configurations (e.g., optionally a broadest reasonable range).

An example is provided below as to equations that may be formulated to model a network and to simulate operation of a production system represented by the network.

Consider a network with n_{N} nodes and n_{B} branches as depicted in FIG. 4. Among the n_{N} nodes, there are n_{IN} internal nodes and n_{BN} boundary nodes. A method can include indexing internal nodes with indices i, i=1, . . . , n_{IN}, branches with j, j=1, . . . , n_{B}, and boundary node with k, k=n_{IN}+1, . . . , n_{N}. Such a method can include letting V_{I} denote the set of internal nodes, and V_{B} denote the set of boundary nodes. For example, a method can include letting V=V_{I}∪V_{B} to denote a set of nodes. Further, such a method can include letting A denote the set of branches. By topology of the network 410 it is also possible to define a set of maps that relate the branches to the nodes. For example, let Φ_{I} denote the map from the branch index j to its inlet node index a; let Φ_{O} denote the map from the branch index j to its outlet node index b; let Φ_{S} denote the map from the branch index j to its geometric start node index s; let Φ_{E} denote the map from the branch index j to its geometric end node index e; and let Φ_{J} denote the map from a node index b to the set of its connected branches. i.e., Φ_{J} (b)={j: Φ_{I}(j)=b or Φ_{O}(j)=b}. Note, as an example, geometric start and end nodes may not necessarily correspond to the inlet and outlet nodes. For example, in a case where they flip, the flow rate Qⱼ in that branch can be negative.

To model the network 410, a set of equations can include terms for conservation of momentum, conservation of mass and conservation of energy. A set of implicit variables may be formulated, for example, where the following are implicit: pressure P at each node, flow rate Q in each branch and temperature T at each node. In such an example, two intermediate variables may be defined as follows: composition C as a function of Q and enthalpy H as a function of P and T.

As an example, an approach that provides flexibility as to treatment of enthalpy/temperature as implicit variables may optionally be applied in situations where, for example, one or more fluids such as heavy oil, water, steam, etc. are present and, for example, where pressure/temperature for one or more fluids are near a critical point (e.g., a vapor-liquid critical point of fluid, above which distinct liquid and gas phases do not exist). To provide enthalpy/temperature flexibility, conservation equations may be defined (e.g., for a Jacobian matrix).

As an example, equipment may be modeled as being adiabatic (e.g., adiabatic devices), for example, on the basis that equipment lengths are substantially smaller than pipe lengths and that heat loss over such equipment can be suitably considered as being negligible. However, for compressors and pumps, a formulation can optionally consider heat gain as a result of loss of total efficiency (e.g., based on manufacturer specifications for efficiency with respect to operational conditions, etc.).

As an example, for instances without an explicit formula for change of enthalpy with respect for pressure and temperature, it is possible to implement one or more flash algorithms provided as a package or packages, for example, to calculate numerical derivatives. As an example, a formulation and solution process may include implementing one or more flash packages that include features to calculate one or more analytical derivatives.

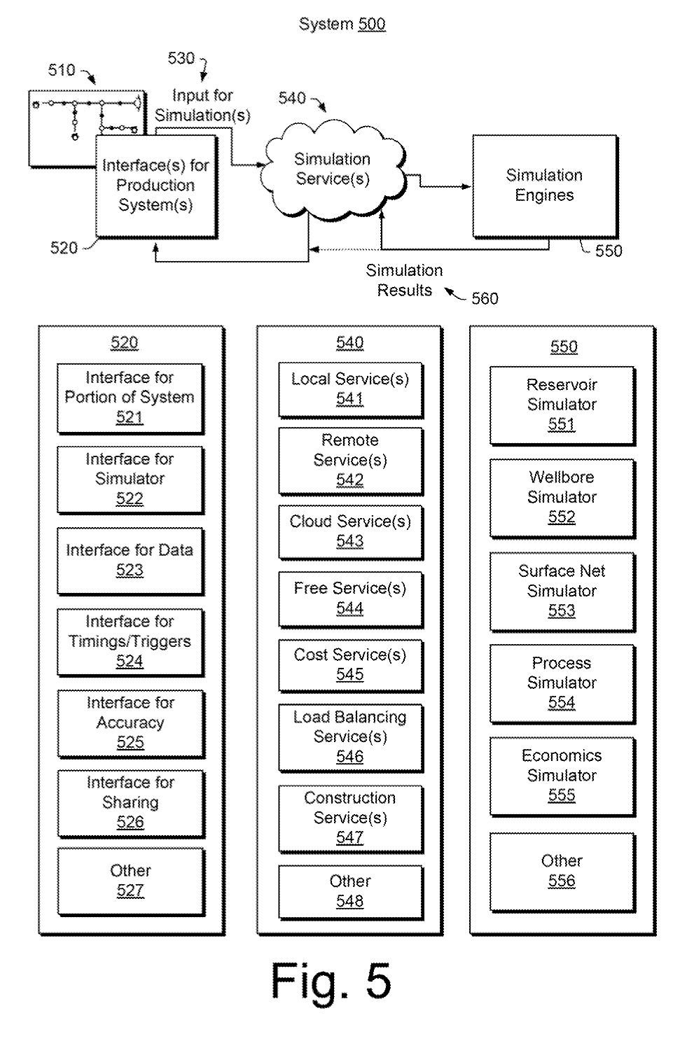

FIG. 5 shows an example of a system 510 that includes one or more models 510, one or more interfaces 520 for interfacing with one or more of the one or more models 510, a communication link(s) 530 for communication of input for one or more simulations, one or more simulation services 540, one or more simulation engines 550 operatively coupled with one or more of the one or more simulation services 540, for example, via a communication link(s) to receive input, instructions, etc. and to output a simulation results 560, etc. As indicated in the example of FIG. 5, output may be directed to one or more of the one or more interfaces 520 via a simulation service or optionally via another route (e.g., direct or indirect).

As an example, the one or more interfaces 520 may include an interface 521 for selecting a portion of a system (e.g., a portion of a pipe network, a portion of a reservoir, etc.), an interface 522 for selecting a simulator, an interface 523 for selecting data, an interface 524 for selecting timings (e.g., turn-around time, triggers, etc.), an interface 525 for selecting accuracy (e.g., grid spacing, node spacing, number of iterations, types of equations, etc.), an interface 526 for sharing (e.g., input from another, output to another, etc.), and one or more other interfaces 527.

As an example the one or more simulation services 540 may include a local service 541, a remote service 542, a cloud service 543, a free service 544, a cost-based service 545, a load balancing service 546 (e.g., to balance loads on resources to perform one or more jobs, etc.), a construction service 547 (e.g., to order construction of a resource to perform one or more tasks, etc.) and one or more other services 548.

As an example, the one or more simulation engines 550 may include a reservoir simulator 551, a wellbore simulator 552, a surface network simulator 553, a process simulator 554, an economics simulator 555, and one or more other simulators 556 (e.g., whether a simulation engine, a data analysis engine, etc.).

As an example, a service may be a local service provided as a unit that may include one or more processors, memory, modules and one or more interfaces. For example, consider a “box” that includes simulation engine components that may be coupled to a system (e.g., a computing device, a computer, etc.) via an interface or interfaces (e.g., wired, wireless, etc.). As an example, consider a unit that may be operatively coupled to a computer via a USB interface. In such an example, discovery of the unit may cause listing of the unit as an available simulation engine (e.g., a resource), for example, that may be accessible via a service manager, optionally integrated into a framework, etc.

As an example, a system may include one or more internally or externally coupled multicore coprocessors to enable faster or continuous simulation of a production system. As an example, a service may provide for delegating tasks of a simulation engine to a coprocessor, for example, to allow for continuous runs in a massively parallel fashion of a production system simulation or simulations. In such an example, “outsourcing” of one or more tasks may alleviate risk of overloading or slowing down a user's machine (e.g., computer). Such an approach may result in increasing overall usability of resources by providing readily available answers as a user changes design or configuration of a production system. Such an approach may enable interactive workflows to design and simulate production systems.

As an example, consider a trigger that responds to a change in a model of a production system where the trigger calls a simulation service and communicates information germane to the change in the model (e.g., a portion of information rather than a full set of information). In such a manner, where a simulation engine managed by the simulation service is in the process of performing a simulation, the simulation may be halted and recommenced taking into consideration the communicated information. As an example, where a simulation engine is not currently performing a simulation for a user that may have made a change in a model, a trigger may call a simulation service and communicate a full set of information germane to performing a simulation by a simulation engine. As an example, where a simulation service, a simulation engine, etc., may have previously been instructed to perform a simulation, an option may exist to communicate a portion of information for a simulation or a full set of information for a simulation.

As an example, depending on the type of change, one or more of a simulation service and a simulation engine may include deciding what information is to be communicated for purposes of performing a simulation. For example, where a type of change is to a boundary condition, information about that boundary condition may be sufficient; whereas, if a new component is introduced into a production system, information as to the type of component, its relationship to other components, etc., may be communicated for purposes of performing a simulation.

As an example, a simulation service may receive change information responsive to a change in a model and filter the change information to provide particular information therein to a simulation engine. In such an example, where the change information does not match information as to input to a simulation engine, a simulation service may optionally respond with a notification (e.g., change not matched to simulation engine capabilities, no simulation to be performed, etc.).

As an example, a simulation service may operatively couple with multiple, different simulation engines. In such an example, a simulation service may parse change information to determine which of the simulation engines may be provided with updated information for purposes of performing simulations. For example, where change information impacts a reservoir and a surface network, a simulation service may parse that information and call for performing a reservoir simulation followed by a surface network simulation. In such an example, the simulation service may follow a hierarchy that sorts information and performs simulations in series, parallel, etc. to accommodate the nature of a change. Such a hierarchy may be in the form of rules and where change information is subject to a rule analysis, information resulting from such an analysis may be communicated to a system that is responsible for the change.

As an example, where multiple users participate collaboratively in modeling of a production system. A simulation service may be configured to receive change information from each of the users. In such an example, the simulation service may mediate simulations based on types of changes, locations of changes, user status, etc.

As an example, a user may start modeling a production system using a modeling user interface (UI) and, as the user creates viable models, the modeling UI communicates with a simulation service, which in turns, communicates with one or more simulation engines, for example, to dispatch new simulation runs in response to changes. In such an example, as results change, a simulation engine may update the simulation service and, consequently, the modeling UI.

As an example, a system may be considered “real-time” in its responsiveness to changes made by a user. In such an example, an interface may present simulation progress along with an associated change or changes. Such an interface may optionally provide for a listing of type of simulation and associated change, which may include a list for past, present and optionally one or more future simulations (e.g., where one simulation is contingent on performing another simulation). As an example, a user may be presented with such information along with timings, costs, etc. An interface may include a “accept” button (e.g., a graphical control, etc.), for example, that allows a user to accept results of one or more simulations proposed by a simulation service. As an example, a system may be configured with one or more options such as, for example, “automatically run viable models” and “run on user request”.

As an example, one or more simulations may be called by a simulation service in response to one or more changes where the one or more simulations run in an automatic mode. Such one or more simulations may run to completion or, for example, run until a change germane thereto is received, which may automatically halt a run and commence a new run based at least in part on the change.

As an example, a simulation service may run on the same hardware as a modeling user interface, on the same hardware of a simulation engine, or on a third hardware platform. As an example, a multiprocessor accelerator may be connected directly to a user's system bus internally (e.g., as an extension card) or may be exterior to the user's system, connected through the network or a USB connection. As an example, a user may be presented with a small branded box (e.g., a PIPESIM® box), that is configured to be operatively coupled to a computer to enable faster or interactive simulations. As an example, input for a simulation and simulation results may be transferred in whole, on-demand, or describing differences from a previous run (e.g., or runs, for example, to capture trends, etc.). As an example, simulation service may support interactive modeling workflows.

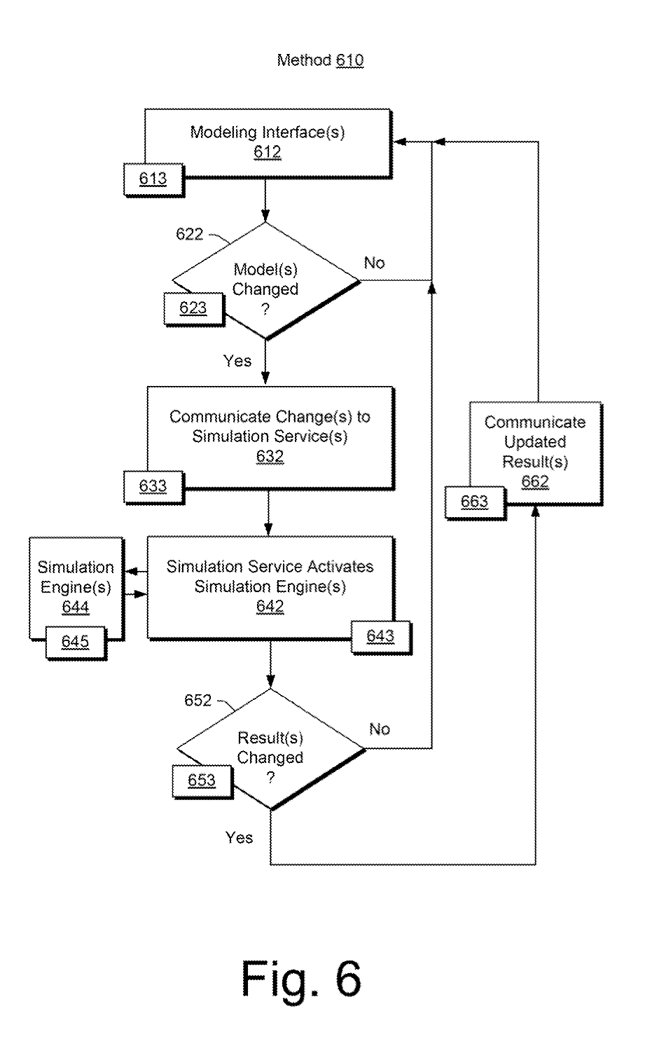

FIG. 6 shows an example of a method 610 that includes a modeling interface block 612 for communicating change information and for receiving results, a decision block 622 for deciding whether a model has changed in a particular manner, a communication block 632 for communicating a change to a simulation service, a simulation service activation block 642 for activation of a simulation engine of a simulation engine block 644, a decision block 652 for deciding whether a result or results from the simulation engine block 644 have changed (e.g., with respect to one or more criteria) and a communication block 662 for communicating updated results to the modeling interface block 612. As an example, the decision block 622 may be part of the modeling interface block 612 or the simulation service block 642 (e.g., or both). As an example, the decision block 652 may be part of a simulation service block 642 or the simulation engine block 644 (e.g., or both). As shown in the example of FIG. 6, where the decision block 622 or the decision block 652 decide that a change has not occurred (e.g., with respect to one or more criteria), the method 610 may continue at the modeling interface block 612. The modeling interface block 612 may include polling of input strokes, variables, parameters, etc. and direct the method 610 to the decision block 622 based at least in part on such polling.

As an example, an interface may include an option to disable simulations, an option to schedule simulations, etc. For example, an interface may include an option to schedule simulations responsive to one or more noted changes to occur over a lunch break time, at the end of a work day, over a weekend, etc. As an example, an interface may provide options to associate types of simulations with particular scheduling options. In such an example, the interface may receive information from a simulation service, which may be real-time information on demand for resources. For example, where resources are cued/backlogged for performing one or more simulations, the simulation service may inform the interface such that the interface can present informed options to a user (e.g., timings for simulations, etc.). In such an example, the simulation service may assist with load balancing, for example, for multiple users that may be requesting shared resources.

The method 610 is shown in FIG. 6 in association with various computer-readable media (CRM) blocks 613, 623, 633, 643, 645, 653 and 663. Such blocks generally include instructions suitable for execution by one or more processors (or processing cores) to instruct a computing device or system to perform one or more actions. While various blocks are shown, a single medium may be configured with instructions to allow for, at least in part, performance of various actions of the method 610. As an example, a computer-readable medium (CRM) may be a computer-readable storage medium.

As an example, a system may be a distributed environment, for example, a so-called “cloud” environment where various devices, components, etc, interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

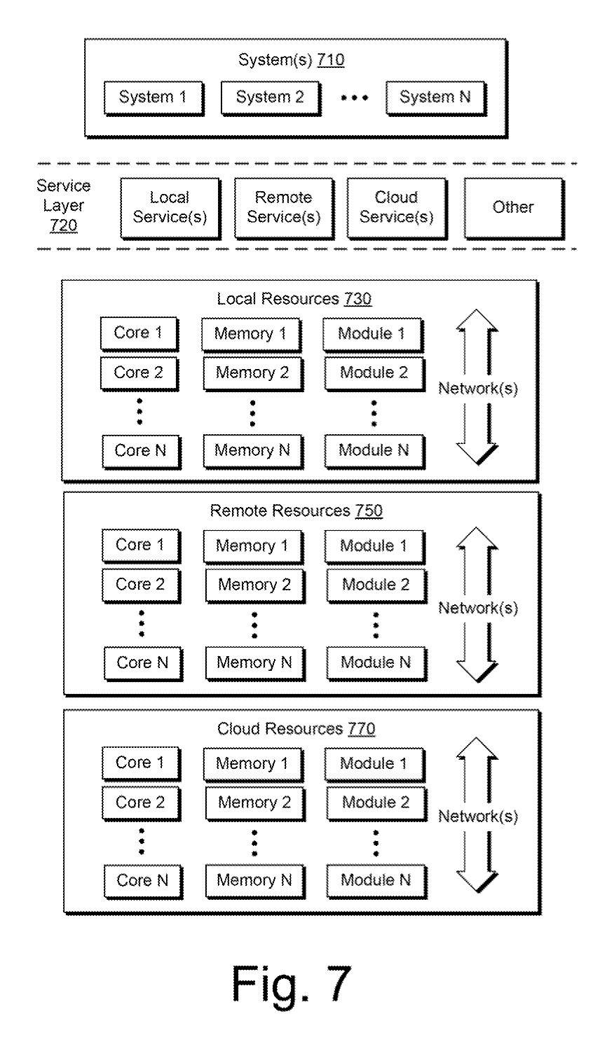

FIG. 7 shows an example of a system 710, a service layer 720 and various types of resources including local resources 730, remote resources 750 and cloud resources 770. As an example, cloud resources 770 may include local resources 730 and remote resources 750, for example, where such resources are available in a cloud environment. As an, example, one or more services of the service layer 720 may operate using one or more of the local resources 730, the remote resources 750 and the cloud resources 770.

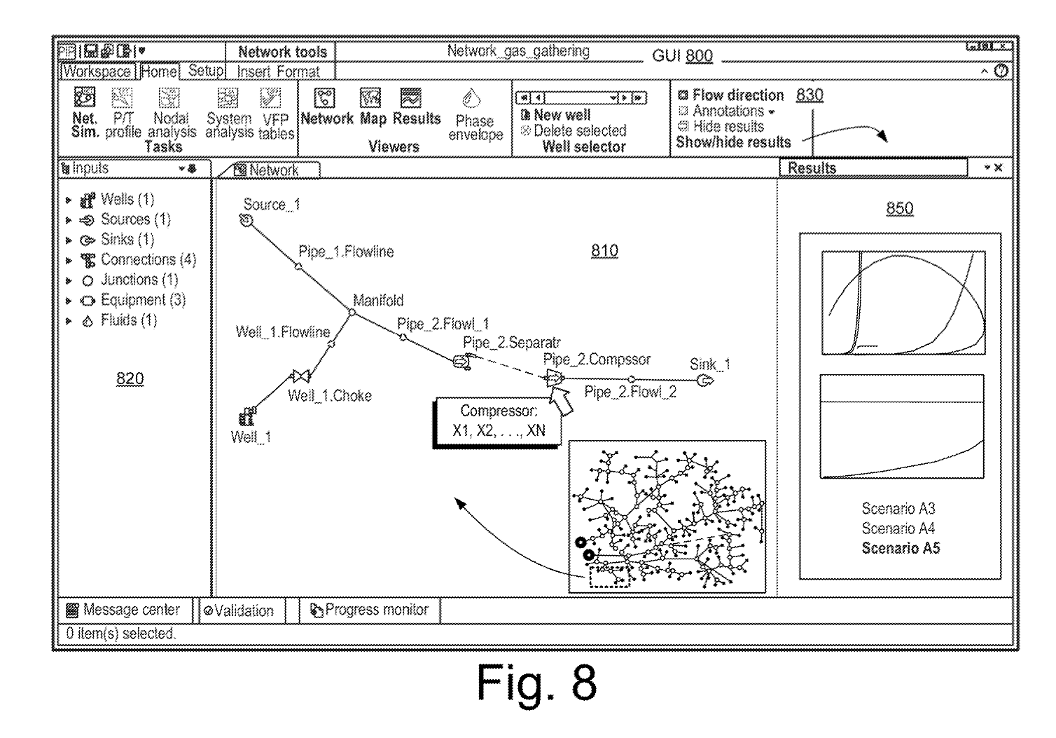

FIG. 8 shows an example of a graphical user interface (GUI) 800 that includes various controls and display regions for display of information, options, etc. As shown in the example of FIG. 8, the GUI 800 includes a region 810 for display of a network (e.g., Network X1), a region 820 for display of inputs (e.g., wells, sources, sinks, connections, junctions, equipment, fluids, etc.), a region 830 for various options including a flow direction option, and a region 850 for a result or result (e.g., optionally via a simulation service, etc.). As shown in the example of FIG. 8, the network may be a portion of a larger network.

As an example, given a flow network to solve, a user may model the network using a network simulator. In such an example, the network simulator may include a single layer (e.g., a uni-layer), for example, where there is no “branch concept” and pieces of equipment are directly exposed (e.g., via flattening). As an example, a network may include equipment (e.g., compressor, source, sinks, flowlines connected, junctions, etc.) to mimic physical or virtual junction points. As an example, one or more pieces of equipment may be unidirectional, bidirectional, directionless and/or have an explicit branch boundary (consider, e.g., a well); noting that many types of pieces of equipment may not.

As an example, a bidirectional piece of equipment can be specified to include a first selectable direction and a second selectable direction (e.g., in terms of a hierarchy). In such an example, when flowing in the first selectable direction, the piece of equipment may have a given behavior that may differ from a given behavior in the second selectable direction (e.g., opposite or reverse to the first selectable direction). As an example, a manifold may provide for splitting its input into a plurality of branches. In such an example, there is a direction (e.g., input to outputs) that causes flow in a forward direction to be divided into the plurality of branches. However, when flow is in an opposite (e.g., reverse) direction, the plurality of branches may serve as inputs and the manifold may aggregate the individual flows of the plurality of branches to an output. As an example, an unidirectional piece of equipment is a piece of equipment that is specified to flow in a particular direction (e.g., a forward direction where flow in a reverse direction is prohibited). As an example, a directionless piece of equipment may be specified to allow for flow in multiple directions, for example, without alteration of behavior.

Referring to the network displayed in the region 810 of the GUI 800, as an example, a method may commence from one or more physical branches (e.g., materialized by a physical junction point or equipment) such as “Source_{—}1” to “Manifold”, “Manifold” to “Sink_{—}1” and then compute flow branches based on one or more equipment characteristics, heuristics and/or rules.

In the example of FIG. 8, a scenario is illustrated whereby input via an input mechanism is received pertaining to a particular portion of the network. For example, a user may navigate a cursor to a piece of equipment and the GUI 800 may, in response, render information to a display that pertains to that piece of equipment. In the example scenario of FIG. 8, the piece of equipment is a compressor and information is displayed in a callout that pertains to the compressor. In such an example, a user may enter a selection as to one or more parameters of the compressor, for example, to change a specification of the compressor (e.g., power, size, etc.). In response to such a selection, which may be a change to the network, information may be transmitted to a simulation service to simulate at least a portion of the network subject to the entered selection (e.g., modification, edit, etc.). In turn, the simulation service may generate simulation results where such results may be received and rendered to the results region 850 of the GUI 800. In such a manner, a user may interact with a network model and understand the consequences of building, changing, etc. the network model in near real-time (e.g., via display of simulation results, etc.).

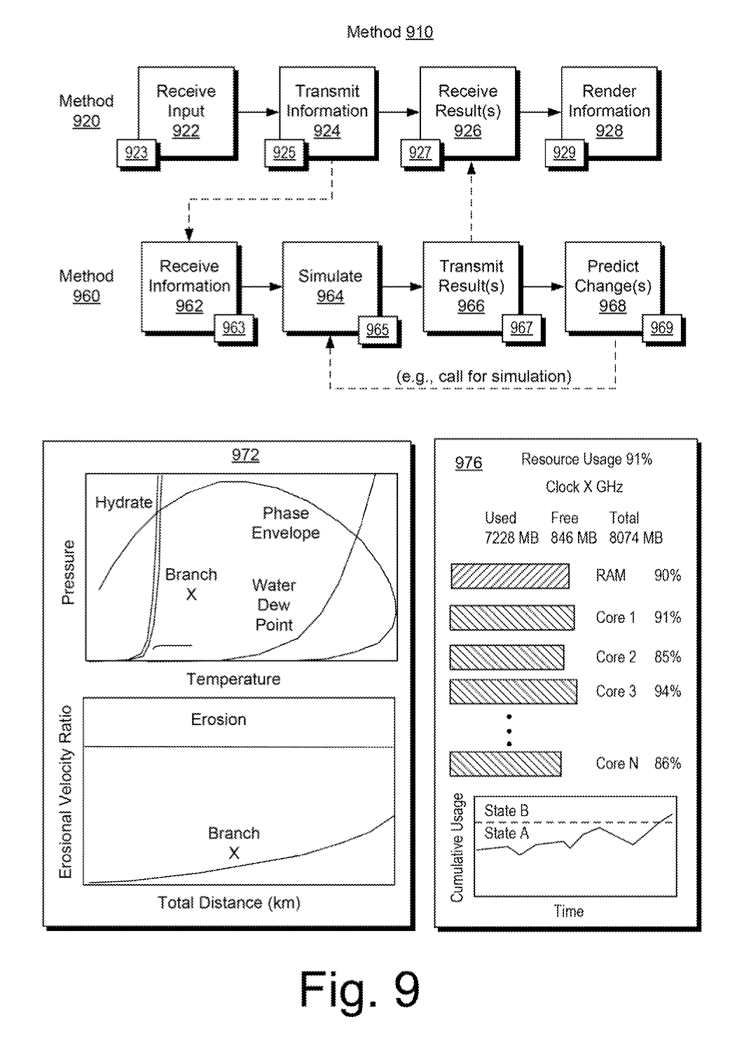

FIG. 9 shows examples of methods 910, 920 and 960 and graphical user interfaces (GUIs) 972 and 976. As indicated in FIG. 9, the methods 920 and 960 may be part of the method 910. As an example, the method 920 may be performed remotely from the method 960. As an example, the method 920 may be performed via a terminal of a computing device and the method 960 may be performed via a computing system that includes a plurality of processor cores, memory, etc. As an example, the method 920 may be performed using lesser computational resources than the method 960.

As shown in FIG. 9, the method 920 includes a reception block 922 for receiving input, a transmission block 924 for transmitting information based at least in part on received input, a reception block 926 for receiving a result or results of a simulation that is based at least in part on transmitted information and a render block 928 for rendering information that is based at least in part on a received result or received results.

As an example, the GUI 972 may be considered information rendered based at least in part on simulation results. For example, a network may include a branch (e.g., Branch X) that spans a distance of kilometers. As simulation of such a network may provide information such as a pressure versus temperature plot that may illustrate a hydrates region, a phase envelope, etc. Such information may include pressure and temperature information for at least a portion of a branch (e.g., Branch X). Further, such information may include erosional information such as erosional velocity ratio information with respect to distance (e.g., location) along a branch (e.g., Branch X).

The results illustrated in the GUI 972 may be associated with a particular scenario for at least a portion of a network such as, for example, the large network illustrated in FIG. 8. Referring again to the results panel 850 of the GUI 800 of FIG. 8, three scenarios A3, A4 and A5 are indicated where the scenario A5 is highlighted as being associated with the information displayed. In such an example, a user may select a prior scenario, for example, to compare simulation results for at least two scenarios. In such a manner, a user may make changes to a network where each change represents a scenario and where each change is communicated to a simulation service to generate simulation results. Where the simulation service returns a result or results in near real-time, a user may expedite network design, investigate more scenarios, more readily optimize a network, etc. In such an example, a user may perform tasks, a workflow, etc. in an interactive manner to investigate multiple scenarios.

In the example of FIG. 9, the GUI 976 may optionally be rendered to a display, for example, to allow a user to determine whether a simulation service can provide for near real-time results. For example, consider the GUI 800 of FIG. 8 as including an option to view simulation service resource utilization information. If upon viewing such information, the user decides that time-lag would be minimal, the user may select to proceed in an interactive manner whereby changes are communicated to the simulation service and returned in near real-time. Alternatively, a user may decide to enter a batch or delayed mode of operation. For example, a user may make changes to a network (e.g., build changes, edits, etc.) over a session and then call for information pertaining to the session to be processed by the simulation service where results may be expected in a period of time that may be of the order of tens of minutes or more.

As an example, the GUI 976 may include a cumulative usage graphic such as, for example, a plot. In such an example, one or more state indicator may be displayed, for example, to determine whether a system may be operative in a certain state (e.g., or mode). For example, where cumulative usage is below a threshold (see, e.g., dashed line), a system may be operative in a real-time operational mode; whereas, where cumulative usage is at or above a threshold, the system may be operative in a batch operational mode (e.g., or other increased latency mode). As an example, a user may determine whether or not to submit input, request simulation results, etc. based in part on observation of a state indicator for a system. As an example, a system may switch operational modes (e.g., for one or more users, etc.) based at least in part on one or more resource utilization criteria (e.g., a cumulative usage threshold, etc.).

As an example, a method may include selecting an operational mode based at least in part on resource information of a simulation service. For example, where resource utilization information indicates that simulations of a network model of a particular size may be handled in near real-time, the method may enter an interactive operational mode. In such a mode, the method may include formulating API calls that transmit information to the simulation service in response to input received via one or more GUIs. Alternatively, the method may enter a local mode, for example, where local storage is used to store inputs received via one or more GUIs and where, for example, such stored inputs may be transmitted at the end of a session to a simulation service. As another example, a method may enter a remote mode that transmits information to a remote storage that may be then used at a later time to perform one or more simulations by a simulation service.

As to the method 960, as shown in FIG. 9, it can include a reception block 962 for receiving information germane to a network model of a production system; a simulation block 964 for simulating at least a portion of the production system based at least in part on a portion of the information and at least a portion of the network model to generate simulation results; and a transmission block 966 for transmitting at least a portion of the simulation results.

As shown in FIG. 9, the reception block 962 may receive input via the transmission block 924 of the method 920 and the transmission block 966 may transmit a result or results to the reception block 926 of the method 920. Accordingly, the method 910 may include one or more of the blocks of the method 920 and one or more of the blocks of the method 960.

As indicated in FIG. 9, the method 960 may optionally include a prediction block 968, which may predict one or more changes to a network (e.g. a network model). For example, if received information and/or results indicate that a user may likely make another change, the method 960 may instruct a simulator to generate simulation results for that change. In such a manner, where the method 960 includes receiving that change, a result or results may already be available and, for example, transmitted for consumption (e.g., viewing, assessment, interpretation, etc.). As an example, consider receiving information that calls for adding a length of pipe in a particular direction. Where the network model includes topography of terrain, a system (e.g., a simulation service, etc.) may predict that another length of pipe will be added in a direction that logically follows the topography of the terrain. As an example, a prediction may be based in part on type or types of equipment that may be specified for a particular type of network, for example, based on type of fluid, flow rate, etc.

Referring again to the GUIs 972 and 976, these may present information generated at least in part by the method 960 and may present information about a system that performs at least part of the method 960. Where a GUI may present resource utilization information (e.g., consumption, availability, etc.) to display, a user may perform a task or tasks (e.g., a workflow, etc.) based at least in part on such information. Such information may provide a user with certainty as to when a result or results may be expected. In turn, the user may be able to more effectively utilize her time.

The method 920 is shown in FIG. 9 in association with various computer-readable media (CRM) blocks 923, 925, 927 and 929. Such blocks generally include instructions suitable for execution by one or more processors (or processing cores) to instruct a computing device or system to perform one or more actions. While various blocks are shown, a single medium may be configured with instructions to allow for, at least in part, performance of various actions of the method 920. As an example, a computer-readable medium (CRM) may be a computer-readable storage medium that is a storage device that is not a carrier wave.

The method 960 is shown in FIG. 9 in association with various computer-readable media (CRM) blocks 963, 965, 967 and 969. Such blocks generally include instructions suitable for execution by one or more processors (or processing cores) to instruct a computing device or system to perform one or more actions. While various blocks are shown, a single medium may be configured with instructions to allow for, at least in part, performance of various actions of the method 960. As an example, a computer-readable medium (CRM) may be a computer-readable storage medium that is a storage device that is not a carrier wave.

As an example, instructions may be stored in one or more computer-readable storage media that are executable by a computer (e.g., via one or more processors) to render a graphical user interface to a display where the graphical user interface may include a panel that displays at least a portion of a network model of a production system (see, e.g., the block 929); to receive input via an input mechanism of the computer where the input is germane to the network model (see, e.g., the block 923); and to formulate a call for transmission to an interface of a simulation service where the call is based at least in part on the input (see, e.g., the block 925). As an example, consider the system 500 of FIG. 5, which may include a computer (e.g., a terminal, a workstation, a mobile device, etc.) configurable via one or more modules, which may be one or more computer-readable storage media that store instructions such as, for example, the aforementioned instructions to render a graphical user interface to a display where the graphical user interface may include a panel that displays at least a portion of a network model of a production system; to receive input via an input mechanism of the computer where the input is germane to the network model; and to formulate a call for transmission to an interface of a simulation service where the call is based at least in part on the input.

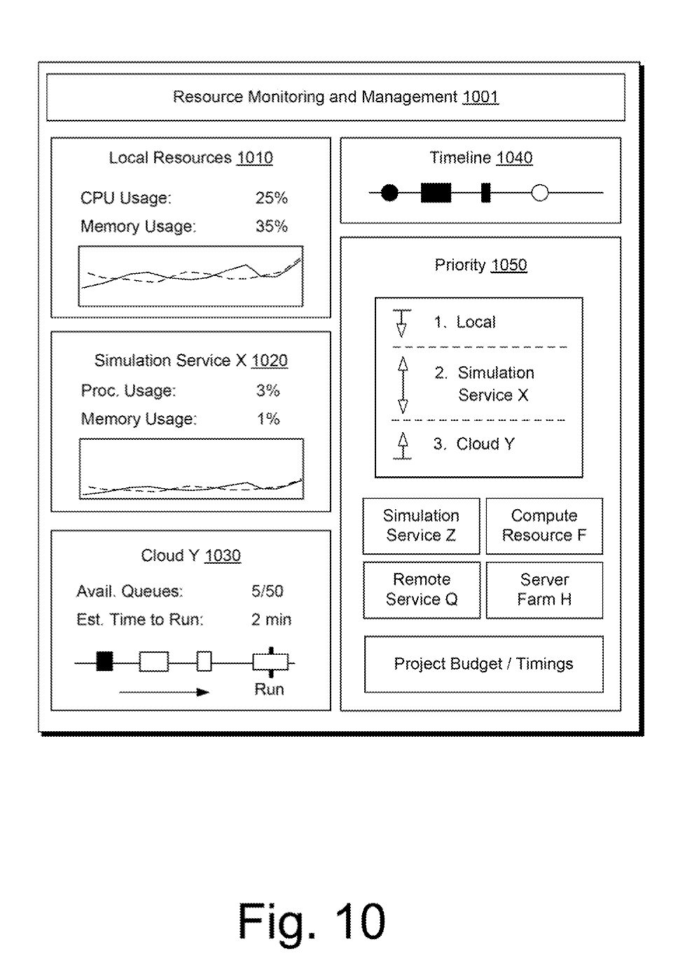

FIG. 10 shows an example of a graphical user interface (GUI) 1010, which may be rendered to a display, for example, via execution of instructions by a computing system. As an example, the GUI 1010 may be a resource monitoring and management GUI. As an example, the GUI 1010 may be rendered to a display associated with a terminal, a workstation, a laptop, a mobile device (e.g., tablet, phone, etc.) or other device.

As shown in the example of FIG. 10, the GUI 1010 may include one or more informational panels such as, for example, a local resource panel 1010, a simulation service panel 1020, a cloud panel 1030, a timeline panel 1040 and a priority panel 1050. As an example, the local resource panel 1010 may display information based on utilization of local resources (e.g., consider a workstation computer). As an example, the simulation service panel 1020 may display information based on utilization of resources associated with a particular simulation service (e.g., Simulation Service X). As an example, a cloud panel 1030 may display information associated with cloud based resources (e.g., cloud computing resources) such as, for example, available queue information, time to run information, etc. In the example of FIG. 10, the cloud panel 1030 illustrates a number of available queues of a total number of available queues and illustrates an estimated time to run. As an example, a time to run may be a wait time before a run, may be an estimated time to complete a run once started, or may be a combined wait time and completion time. As an example, a timing graphic may be displayed that may indicate a queue (e.g., serial and/or parallel depending on resource type and management) that may allow a user to see jobs in the queue and where the user's job may be (see, e.g., black box). Such a graphic may indicate size of job, for example, by width on a timeline.

As an example, the timeline panel 1040 may display information specific to a users tasks, jobs, etc. For example, the timeline panel 1040 may display information as to tasks that may be part of a workflow. In such a manner, a user may readily see where the is in a particular workflow. As an example, the tasks may be represented graphically and may be selected, for example, to display results, parameters, etc. As shown, black-filled graphics may indicate completed tasks while an open graphic may indicate a task that is to be performed.

As an example, a user may take a break, go home at the end of a day, etc. and then return and review a workflow in progress via the timeline panel 1040. Via the GUI 1010, a user may assess resources available prior to taking a break, going home, etc., for example, to initiate a task using resources optionally where the task may be performed while the user is away (e.g., at home, on break, etc.). As shown in the example of FIG. 10, the GUI 1010 may display workflow tasks and resource utilization and availability in a manner that more effectively allows a user to perform one or more workflows. More generally, the GUI 1010 may allow a user to monitor and manage resources to perform one or more tasks.

As to the priority panel 1050, as shown, resources may be prioritized. For example, a user may desire utilization of local resources where those resources are sufficient to perform a task, followed by utilization of a simulation service and then cloud resources. A user may optionally manage priorities and resources. For example, the panel 1050 may display a variety of available resources (e.g., Simulation Service Z, Compute Resource F, Remote Service Q, Server Farm H, etc.). As an example, the panel 1050 may include a graphic that allows a user to visualize project budget and/or project timing information. For example, certain resources may have associated costs. As an example, where a user wants to speed up a workflow by speeding up a simulation, the user may assess a project budget and purchase available computation resources to perform that simulation on an expedited basis (e.g., to meet one or more project timings). As an example, where a change in project timings may occur, the GUI 1010 may cause a notification to be issued, for example, by highlighting a graphic. A user may then assess the change and decide how to proceed with a task, tasks, workflow, etc. (e.g., whether to expedite by using additional resources, to slow down and save money by utilizing less expensive resources, etc.).

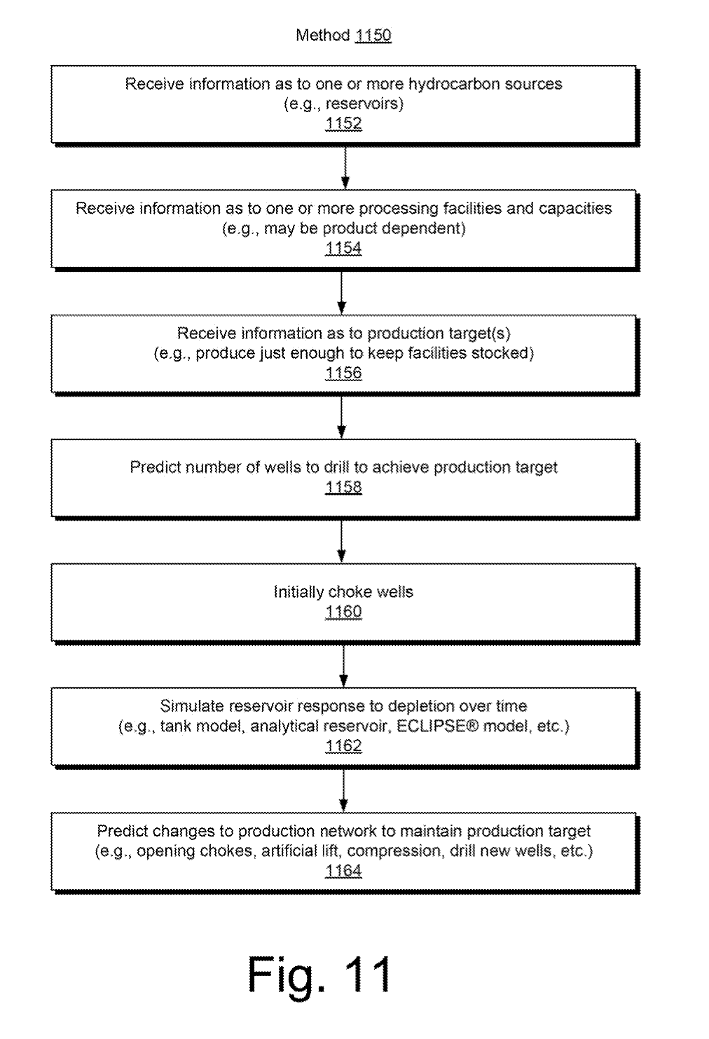

FIG. 11 shows an example of a method 1150 that include a reception block 1152 for receiving information as to one or more hydrocarbon sources (e.g., reservoirs, etc.), a reception block 1154 for receiving information as to one or more processing facilities and capacities (e.g., optionally product dependent), a reception block 1156 for receiving information as to one or more production targets (e.g., produce just enough to keep facilities stocked, etc.), a prediction block 1158 for predicting a number of wells to drill to achieve a production target (e.g., or targets), an optional initialization block 1160 for initially choking the wells, a simulation block 1162 for simulating a reservoir response to depletion over time (e.g., using a tank model, analytical reservoir, an ECLIPSE® framework model, etc.), and a prediction block 1164 for predicting changes to a production network to maintain one or more of the one or more production targets (e.g., via opening chokes, artificial lift, compression, fracturing, drilling additional wells, etc.).

As an example, a user may specify one or more hydrocarbon sources (e.g., one or more reservoirs), one or more processing facilities and their capacities which may be product dependent and one or more production targets (e.g., produce just enough to keep facilities stocked). In turn, a computing system may, based on such user specifications, predict a number of wells to drill to achieve at least one specified production target. In such an example, the computing system may perform one or more actions that may lead to further predictions. For example, a computing system may perform a simulation that includes initially choking the predicted number of wells, simulating a reservoir response (e.g., tank model, analytical reservoir, eclipse) to depletion over time, and predicting changes to a production network to maintain one or more production targets where, for example, a prediction may be in the form of opening one or more chokes, utilizing artificial lift techniques/equipment, utilizing compression, drilling new wells, etc. (e.g., associated with the production network).

As an example, the method 1150 of FIG. 11 may include utilizing resources such as one or more of the resources described with respect to the GUI 1010 of FIG. 10. As an example, such resources may be utilized in response to receipt of information. For example, as a user inputs (e.g., specifies) information as to one or more production targets for a production system, a computing system may commence a prediction method that aims to predict information that may be useful to the user. For example, upon entering a production target for an at least partially specified production system (e.g., a production network), a computing system may, in response to input of the production target, commence one or more simulations where results thereof may guide the user as to further specifying the production network (e.g., by editing and/or adding wells, equipment, paths, etc.). As an example, a computing system may be forward-thinking where it may utilize available resources to generate information that may assist a user in decision making, performing a workflow, etc.

As an example, production systems may provide for transportation of oil and gas fluids from well locations to processing facilities and represent an investment in infrastructure with both economic and environmental impact. Simulation of these systems, which may include hundreds or thousands of flow lines and production equipment interconnected at junctions to form a network, can involve use of multiphase flow science and engineering and mathematical methods (e.g., to solve large systems of non-linear equations).

As size of a production system under simulation increases, the number of independent calculations may increase. As an example, a system or systems may implement parallel processing and/or one or more other types of processing. Some examples for processing include cluster system processing, node bound processing and small package device processing. Low power, compact format units for specialized computing are becoming more readily available (consider, e.g., Adapteva Parallella board, Mont Blanc European project for supercomputing, etc.). Some additional processing examples include those that include accelerators (e.g., GPGPUs, INTEL® Xeon Phi, NVIDIA® GPUs, accelerators, etc.)

As an example, a system may include multiple processing elements that may be configured to execute concurrent tasks execute in parallel. In such an example, elements may be real, physical elements and/or virtual elements (e.g., consider virtualization of one or more processors, cores, etc.). As an example, a virtual machine or virtual machines may be instantiated on a system or systems, which may provide operating system environments that can execute an application or applications.

As an example, a system may include one or more modules for executing a hypervisor or hypervisors. In such an example, a hypervisor may perform actions, for example, to manage one or more virtual machines (e.g., one or more guest machines, etc.).

As an example, a system may include modules that provide for parallel networking of computers. In such an example, the computers may be leveraged for use as a distributed parallel processing system.

As an example, a system may include one or more modules for partitioning a model of a network of a production system into portions. In such an example, each of the portions may include one or more branches and/or one or more pieces of equipment. As an example, individual portions may be assigned to processing resources. For example, a processor core may be a processing resource that includes accessible memory, which may also be considered a processing resource. In such an example, processing may occur concurrently for multiple individual portions of the model of the network of the production system.

As an example, a system may include a master application that can partition tasks for execution via slave applications. In such an example, the slave applications may execute in operating system environments that may be established using cores, for example, where individual cores provide for individual operating system environments. As an example, a system may include one or more multicore processors. In such an example, a master application may execute in an operating system environment that can leverage multiple cores for execution of slave applications. As an example, a master application may be configured to perform tasks associated with a model of a network of a production system and the slave applications may be configured to perform tasks associated with individual portions of the model of the network of the production system, which may be portions optionally specified to a branch level (e.g., where the model of the network includes multiple branches that represent real and/or hypothetical physical branches of a production system). As an example, results from slave applications may be consolidate by a master application, which may be optionally configured to call for rendering information (e.g., via one or more GUIs, etc.).

As an example, a framework may include a parallel solver, for example, to solve equations associated with a model of a network of a production system using resources configured for concurrent processing. As an example, a parallel solver may provide for distributed processing using resources with a system or disparate systems (e.g., network connected systems, etc.).

Simulation time of large production networks may, for some examples, be measured in hours where the process of building a model is a non-interactive one, as the user continually adjusts model and simulation parameters and occasionally actuates a run button (e.g., selects a graphical control, enters a command, etc.) to run the simulation. As an example, a simulation service may decrease execution time for a network simulation as well as diminish the long-latency process of building a model by enabling interactive runs of a model as it is built. As an example, an outsourcing approach that diminishes execution time for a simulation can alleviate slowdown of a user machine, which, in turn, may increase productivity of a user. Resources for outsourcing may be resident on a user machine, locally coupled thereto, remote and/or cloud-based. As an example, a simulation service may allow for a simulation to run in a relatively continuous manner, for example, responsive to creation, editing, etc. of a model of a production system.

As an example, a method can include, via an interface of a computing system, receiving information representing a change to a network model of a production system; via the computing system, simulating at least a portion of the production system based at least in part on a portion of the information and at least a portion of the network model to generate simulation results; and, via the interface, transmitting at least a portion of the simulation results. In such an example, the simulating may be initiated in response to receiving the information. As an example, information received may be information of an application programming interface (API) call.

As an example, a method may include predicting a change to a network model of a production system and simulating at least a portion of the production system based at least in part on the predicted change. In such an example, predicting the change may be based at least in part on analyzing at least a portion of received information (e.g., previously received information for which a simulation was performed). As an example, a method may include predicting a change based at least in part on analyzing at least a portion of simulation results. As an example, a method may include transmitting a predicted change via an interface. For example, a predicted change may be transmitted via an interface to a computing device where the computing device may render a GUI to a display that may allow a user to select the predicted change (e.g., as a scenario). In such an example, the user may know that a simulation result or results are available for the predicted change and, if desired, call for transmission and presentation of the result or results.

As an example, a method may include predicting a change to a network model by simulating at least a portion of the production system and, for example, transmitting the predicted change via an interface. For example, given particular input as to a production network, a computing system may commence a simulation of that production network that may extend to one or more scenarios for one or more future times. Based on such a simulation (e.g., or simulations), the computing system may predict one or more changes that may be beneficial for the production network. For example, where input includes a production target, a change may be to install one or more pieces of equipment that can help to meet the production target. As an example, a predicted change to a production network may include performing an action and/or addition of equipment and/or features. For example, an action may be fracturing, compressing, lifting artificially, etc. while an addition of equipment and/or features may be adding one or more wells, adding one or more electric submersible pumps, adding SAGD equipment, adding a compressor, adding another pipeline, etc.

As an example, a method may include transmitting via an interface resource utilization information of a computing system. In such an example, the computing system may be a computing that implements a simulation service or that can implement a simulation service. As an example, resource utilization information may include memory utilization information and/or processor utilization information.

As an example, a system can include an interface; processor cores; memory accessible by the processor cores; one or more modules stored in the memory where the one or more modules include processor-executable instructions to instruct the system to receive via the interface information germane to a network model of a production system; simulate via at least one of the processor cores at least a portion of the production system based at least in part on a portion of the information and at least a portion of the network model to generate simulation results; and transmit via the interface at least a portion of the simulation results. In such an example, the information germane to the network model may represent one or more changes to a previous version of the network model.

As an example, one or more modules may include processor-executable instructions to instruct a system to predict a change to a network model of a production system and to simulate at least a portion of the production system based at least in part on the predicted change to generate simulation results and/or to instruct the system to predict a change to the network model by simulating at least a portion of the production system.

As an example, a system may include an application programming interface (API). In such an example, the API may include a specification that specifies a plurality of API calls.

As an example, a system may receive information germane to a network model of a production system where, for example, the information is generated at least in part by a graphical user interface that renders at least a portion of the network model to a display.

As an example, one or more computer-readable storage media can include computer-executable instructions executable by a computer to instruct the computer to: render a graphical user interface to a display where the graphical user interface includes a panel that displays at least a portion of a network model of a production system; receive input via an input mechanism of the computer where the input is germane to the network model; and formulate a call for transmission to an interface of a simulation service where the call is based at least in part on the input. In such an example, the one or more computer-readable storage media may include computer-executable instructions executable by the computer to instruct the computer to receive a response to a call where the response includes information and to render information to the display based at least in part on the information.

As an example, one or more computer-readable storage media may include computer-executable instructions executable by a computer to instruct the computer to receive resource utilization information of a simulation service and to regulate transmission of one or more calls to the simulation service based at least in part on the resource utilization information. In such an example, the resource utilization information may include memory utilization information, processor utilization information or memory utilization information and processor utilization information.

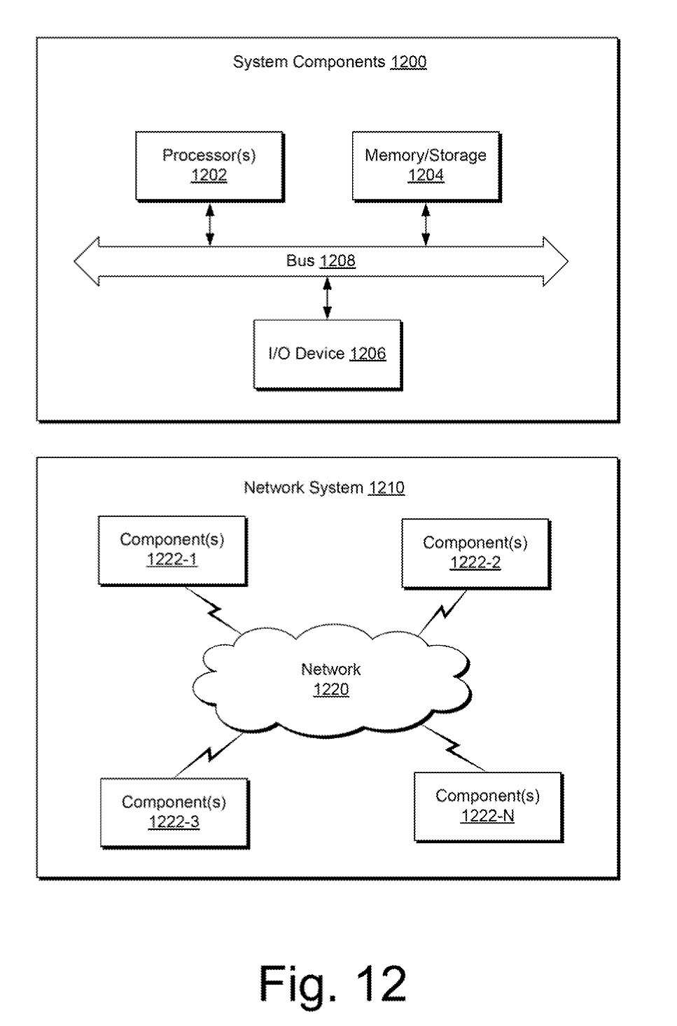

FIG. 12 shows components of an example of a computing system 1200 and an example of a networked system 1210. The system 1200 includes one or more processors 1202, memory and/or storage components 1204, one or more input and/or output devices 1206 and a bus 1208. In an example embodiment, instructions may be stored in one or more computer-readable media (e.g., memory/storage components 1204). Such instructions may be read by one or more processors (e.g., the processor(s) 1202) via a communication bus (e.g., the bus 1208), which may be wired or wireless. The one or more processors may execute such instructions to implement (wholly or in part) one or more attributes (e.g., as part of a method). A user may view output from and interact with a process via an I/O device (e.g., the device 1206). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1210. The network system 1210 includes components 1222-1, 1222-2, 1222-3, . . . , 1222-N. For example, the components 1222-1 may include the processor(s) 1202 while the component(s) 1222-3 may include memory accessible by the processor(s) 1202. Further, the component(s) 1202-2 may include an I/O device for display and optionally interaction with a method. The network may be or include the Internet, an intranet, a cellular network, a satellite network, etc.

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

What is claimed is:

1. A method comprising:
via an interface of a computing system, receiving information representing a change to a network model of a production system;
via the computing system, simulating at least a portion of the production system based at least in part on a portion of the information and at least a portion of the network model to generate simulation results; and
via the interface, transmitting at least a portion of the simulation results.

2. The method of claim 1 wherein the simulating is initiated in response to receiving the information.

3. The method of claim 1 wherein the information comprises information of an application programming interface (API) call.

4. The method of claim 1 further comprising predicting a change to the network model and simulating at least a portion of the production system based at least in part on the predicted change.

5. The method of claim 4 further comprising transmitting the predicted change via the interface.

6. The method of claim 1 further comprising predicting a change to the network model by simulating at least a portion of the production system.

7. The method of claim 6 further comprising transmitting the predicted change via the interface.

8. The method of claim 1 further comprising transmitting via the interface resource utilization information of the computing system.

9. The method of claim 8 wherein the resource utilization information comprises memory utilization information.

10. The method of claim 8 wherein the resource utilization information comprises processor utilization information.

11. A system comprising:
an interface;
processor cores;
memory accessible by the processor cores;
one or more modules stored in the memory wherein the one or ore modules comprise processor-executable instructions to instruct the system to
receive via the interface information germane to a network model of a production system;
simulate via at least one of the processor cores at least a portion of the production system based at least in part on a portion of the information and at least a portion of the network model to generate simulation results; and
transmit via the interface at least a portion of the simulation results.

12. The system of claim 11 wherein the information germane to the network model represents one or more changes to a previous version of the network model.

13. The system of claim 11 wherein the one or more modules comprise processor-executable instructions to instruct the system to predict a change to the network model and to simulate at least a portion of the production system based at least in part on the predicted change to generate simulation results and instructions to instruct the system to predict a change to the network model by simulating at least a portion of the production system.

14. The system of claim 11 wherein the interface comprises an application programming interface (API).

15. The system of claim 14 wherein the API comprises a specification that specifies a plurality of API calls.

16. The system of claim 11 wherein the information germane to a network model of a production system comprises information generated at least in part by a graphical user interface that renders at least a portion of the network model to a display.

17. One or more computer-readable storage media comprising computers executable instructions executable by a computer to instruct the computer to:
render a graphical user interface to a display wherein the graphical user interface comprises a panel that displays at least a portion of a network model of a production system;
receive input via an input mechanism of the computer wherein the put is germane to the network model; and
formulate a call for transmission to an interface of a simulation service wherein the call is based at least in part on the input.

18. The one or more computer-readable storage media of claim 17 comprising computer-executable instructions executable by the computer to instruct the computer to receive a response to a call wherein the response comprises information and to render information to the display based at least in part on the information.

19. The one or more computer-readable storage media of claim 17 comprising computer-executable instructions executable by the computer to instruct the computer to receive resource utilization information of a simulation service and to regulate transmission of one or more calls to the simulation service based at least in part on the resource utilization information.

20. The one or more computer-readable storage media of claim 19 wherein the resource utilization information comprises memory utilization information, processor utilization information or memory utilization information and processor utilization information.
